(19) United States
(12) Patent Application Publication
(10) Pub. No.: US 2025/0371203 A1
(43) Pub. Date: Dec. 4, 2025

(54) METHODS FOR AUTOMATICALLY GENERATING ENGINEERING DRAWINGS

(71) Applicant: Drafter Inc., Denver, CO (US)

(72) Inventors: Christopher Barton, Denver, CO (US); Peter Atkin, Denver, CO (US)

(21) Appl. No.: 19/228,434

(22) Filed: Jun. 4, 2025

Related U.S. Application Data
(60) Provisional application No. 63/656,028, filed on Jun. 4, 2024.
(60) Provisional application No. 63/677,344, filed on Jul. 30, 2024.

(51) Int. Cl. G06F 30/12; G06F 111/04; G06T 19/20

(52) U.S. Cl. CPC G06F 30/12; G06T 19/20; G06F 2111/04

(57) ABSTRACT

One variation of a method includes: accessing a rendering of a model depicting features of a part; accessing a set of target features of the rendering and a function of the part, the function defining a constrained degree of freedom for the part; defining a set of datums intersecting a subset of target features that constrain the part according to the constrained degree of freedom; populating an engineering drawing with a set of projections of the rendering; annotating edges of the subset of target features in the set of projections with datum callouts; annotating edges of the set of target features in the set of projections with feature control frames; annotating a set of edges in the set of projections with the basic dimension callouts representing numerical dimensions relative to the set of datums and reference dimension callouts representing maximal dimensions of the part; and rendering the engineering drawing.

### CROSS-REFERENCE TO RELATED APPLICATIONS

This application claims the benefit of U.S. Provisional Application No. 63/677,344, filed on 30 Jul. 2024, and U.S. Provisional Application No. 63/656,028, filed on 4 Jun. 2024, each of which is incorporated in its entirety by this reference.

### TECHNICAL FIELD

This invention relates generally to the field of engineering drawing automation and, more specifically, to a new and useful method for automatically generating an engineering drawing representing geometric dimensions and tolerances of a part.

### BACKGROUND

Geometric Dimensioning and Tolerancing (or “GD&T) is a fundamental system used in defining and communicating permissible manufacturing variations in size, form, and/or orientation of critical features within a part or an assembly. The process of manually generating an engineering drawing representing geometric dimensions and tolerances of a part requires extensive knowledge of a symbolic language, interpretation of a corpus of rules and guidelines (or “best practices”) in view of a particular part, and meticulous detailing of critical features based on the symbolic language, rules, and best practices. This process is time-consuming, prone to errors, and requires significant expertise to accurately capture and depict critical features in an engineering drawing. These limitations can lead to inconsistencies in interpretation, increased manufacturing costs due to manufacturing errors, and increase resources dedicated by engineers and/or manufacturers in drawing revision.

### BRIEF DESCRIPTION OF THE FIGURES

FIG. 1 is a flowchart representation of a method.

FIG. 2 is a flowchart representation of one variation of the method;

FIG. 3 is a flowchart representation of one variation of the method;

FIG. 4 is a flowchart representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

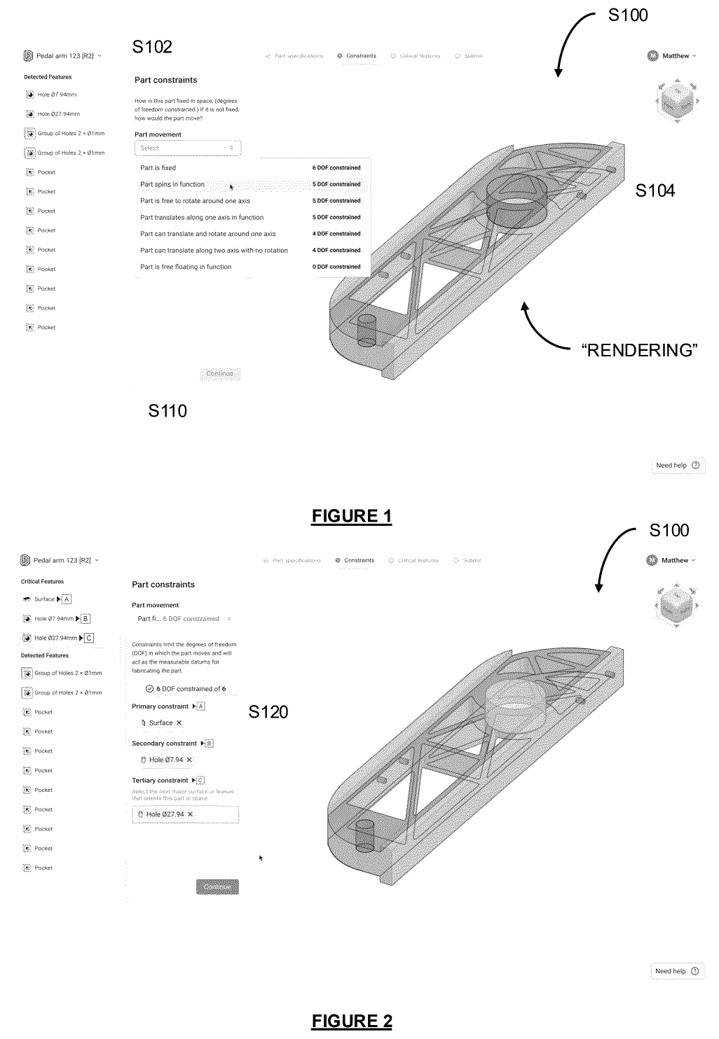

As shown in FIGS. 1-5, a method S100 includes: accessing a three-dimensional, computer-generated model (hereinafter the “model”) of a part in Block S102; generating a rendering of the model, the rendering depicting a set of features of the part, within a user portal in Block S104; prompting a user to indicate a function of the part, the function defining a constrained degree of freedom for the part in Block S110; prompting the user to select a set of target features on the rendering in Block S120; isolating a subset of target features, in the set of target features, that in combination constrain the part according to the constrained degree of freedom; defining a set of datums intersecting the subset of target features in Block S130; and populating an engineering drawing with a set of projections of the rendering in Block S140.

The method S100 also includes, for each feature in the subset of target features: accessing a feature type corresponding to the feature; accessing a set of best practices for a set of datum callouts based on the feature type; generating a datum callout based on a datum, in the set of datums, and the set of best practices corresponding to the feature; and annotating a set of edges, depicting the feature in the set of projections, with the datum callout in Block S150.

The method S100 also includes, for each feature in the set of target features: extracting a characteristic of the feature from the rendering; retrieving a nominal tolerance for the feature based on the characteristic; generating a feature control frame, in a set of feature control frames, for the feature based on the characteristic, the nominal tolerance, and a datum; and annotating an edge, depicting the feature in the set of projections, with the feature control frame in Block S155. The method S100 also includes: generating a set of basic dimension callouts representing a numerical dimension relative to a datum, in the set of datums; annotating a set of edges, depicted in the set of projections, with the set of basic dimension callouts in Block S160; generating a set of reference dimension callouts representing maximal dimensions of the part; annotating a set of edges, depicted in the set of projections, with the set of reference dimension callouts in Block S165; and rendering the engineering drawing in Block S170.

### 2. Applications

Generally, the method S100 can be executed by a system (e.g., a remote computer system, a computer network, a remote server) in conjunction with a user portal and/or application (e.g., native or web application). The system can execute Blocks of the method S100: to ingest a model (e.g., a CAD model) and codify a projection of the corpus of rules and best practices, in view of the model and a sequence of user inputs, to a Geometric Dimensioning and Tolerancing drawing (or “engineering drawing”) representing the model. In particular, the system can execute Blocks of the method S100: to identify the features of the model (e.g., lines, edges, surfaces, holes, etc.); receive user inputs indicating target (or “critical”) features of the model; and interpret the rules and best practices in view of the features and user-specified critical features to generate a set of engineering drawing elements (e.g., required views, feature callouts, etc.) effectively conveying critical part features and dimensions of the model, ensuring precise manufacture for intended functionality.

Furthermore, the system can execute Blocks of the method S100: to generate an accurate engineering drawing representing the projection of best practices and capturing the design intent of the part (i.e., for issuing to a manufacturer in combination with a CAD model representing the part). The system can repeat this process to generate engineering drawings representing different parts and/or assemblies by applying a unique, individualized projection of best practices and user inputs unique to each engineering drawing. Therefore, the system can generate consistent, reliable drawings independent of the expertise of the user, thereby reducing resources allocated to generating, correcting, revising, and interpreting such engineering drawings.

In particular, the system can execute Blocks of the method S100: to receive a model of a part from a user; to guide the user through a sequence of prompts, collect information associated with the part's design intent, and leverage the user inputs to generate an engineering drawing with applicable GD&T representing the part; and to define elements of the engineering drawing (e.g., required part views, feature callouts, etc.) based on characteristics of each feature of the part. Therefore, the system can capture both the GD&T specifications and the Product Manufacturing Information (or “PMI”) for a part, thereby generating robust engineering drawings representing geometric tolerances, material specifications, and/or manufacturing notes in a single format for interpretation by a manufacturer.

### 2.1 Drawing Generation Module

In one application of the method S100, a system can render the engineering drawing based on a set of user-specified inputs, such as the functionality (or “design intent”) of the part, features critical to the functionality of the part, and/or features requiring precision dimensioning in the engineering drawing. In particular, in this application, the system can: receive the model of the part from the user; generate a rendering from a model of a part received from a user; prompt the user to input information related to the part (e.g., the intended part function, features critical to the intended part function, etc.), such as by selecting features represented in the rendering; define a set of datums based on the user-selected inputs; annotate a set of projections of the rendering with a set of callouts for the drawings (e.g., datums, dimensions, etc.); and render the engineering drawing representing the part.

For example, in the foregoing application, a system can: receive a three-dimensional model of a part (e.g., a CAD model of part of an automotive pedal assembly) from a user; parse the model to extract each individual feature of the part (e.g., lines, edges, surfaces, holes, etc.); and map each feature to the rendering of the part. In this example, the system can: receive selection of the intended function of the part (e.g., the part is fixed in the automotive pedal assembly); receive selection of a set of features critical to the functionality of the part (e.g., a set of holes each configured to mate with a fastener, a surface restricting the motion of the part, etc.), such as via selection of features in the rendering; and define a set of datums that constrain the part according to the intended function and based on the features selected by the user (e.g., a set of datums that in combination constrain six degrees of freedom of the part and intersect with the user-selected features). In this example, the system can: generate a set of feature callouts for the user-selected features representing dimensions and/or tolerances relative to the set of datums; annotate a set of projections of the rendering with the feature callouts; and render an engineering drawing representing the part and including the annotated set of projections (e.g., for issuing to a manufacturer for fabrication of the part). Therefore, the system can compile the set of user inputs and transpose the model into an engineering drawing effectively conveying critical part features and dimensions, ensuring precise manufacture for intended functionality.

### 2.2 Drawing Element Selection

In another application of the method S100, the system can define elements of the engineering drawing (e.g., required part views, feature callouts, etc.) based on characteristics of each feature in the part. In particular, in this application, the system can: receive the model (e.g., a CAD model) of the part from the user; parse the model to extract each individual feature of the part (e.g., lines, edges, surfaces, holes, etc.); for each feature in the model, extract a set of characteristics (e.g., feature type, view type, user-specified criticality, etc.); consolidate a set of views for the engineering drawing (e.g., a front view, orthogonal view, isometric view, auxiliary view, and/or section view) based on a view type defined for the feature based on the set of characteristics; and consolidate a set of feature callouts (e.g., feature control frames) based on the set of characteristics and user-specified criticality of the feature.

For example, in the foregoing application, the system can: receive a three-dimensional model of a part (e.g., a CAD model of part of an automotive pedal assembly) from a user; parse the model to extract each individual feature of the part (e.g., lines, edges, surfaces, holes, etc.); consolidate a set of views for the engineering drawing based on the features extracted from the drawing, the set of views including a front view, an orthogonal view, and a section view; and consolidate a set of datum callouts including three datum callouts, a set of six feature control frames, a set of five basic dimension callouts, and a set of two reference dimension callouts for the engineering drawing. Therefore, the system can eliminate redundant information in the engineering drawing by selecting and/or consolidating the elements of the engineering drawing (e.g., different views, feature callouts, etc.) based on the characteristics of each feature.

### 2.3 Drawing Revisions

In another application of the method S100, the system can receive a modified CAD model corresponding to a modified version of a part from a user and leverage user-selected parameters from the unmodified CAD model to expedite the drawing generation process for the modified CAD model. In particular, in this application, the system can: identify the modified CAD model as a revision of the unmodified CAD model (e.g., based on matching features identified in the modified CAD model and the unmodified CAD model); define a set of engineering drawing elements (e.g., datums, feature callouts, etc.) for the modified CAD model based on the engineering drawing elements of the unmodified CAD model; prompt the user to review the features in the modified model devoid of a corresponding feature in the unmodified model (i.e., the revised features); and generate a new engineering drawing representing the modified CAD model.

For example, in the foregoing application, at a first time, a system can: generate an engineering drawing for an unmodified model (e.g., a part of an automotive pedal assembly); and label each feature of the unmodified model with a feature identifier unique to the feature. At a second time succeeding the first time, the system can: receive a model of a modified part (i.e., a modified version of the unmodified part); identify the modified model as a revision of the unmodified model (e.g., based on matching features identified in the modified model and the unmodified model); and label each matching feature in the modified model based on the matching feature identifier in the unmodified model. In response to the matching features including each user-selected critical feature from the unmodified model, the system can leverage the user-selections to: define a set of datums and a set of feature callouts for the modified model; and populate the sequence of prompts with the user selections. The system can then: prompt the user to review the features lacking a match in the unmodified model (i.e., the revised features); and generate a new engineering drawing representing the modified part. Therefore, the system can leverage user-selected parameters (e.g., datums, feature callouts, etc.) from the unmodified model to expedite the drawing generation process for the modified model.

2.4 Remote v. Local Execution

Generally, the method S100 is described herein as executed by a remote computer system in conjunction with a user portal (e.g., a native application or web application) executing on a computing device (e.g., a mobile device, a computer). However, the method S100 can additionally or alternatively be executed by a local computer system in conjunction with the user portal executing on the computing device.

### 3. Model Ingest

Generally, the system can receive a model of a part from a user (e.g., a three-dimensional CAD model uploaded by the user). In particular, the system can interface with a user portal (e.g., a native application or web application) executing on a computing device (e.g., a mobile device, a computer) accessed by the user to receive the model. The system can then guide and/or support the user through a module to generate an engineering drawing for the part, as described in more detail below.

### 4. Rendering

Generally, receiving the model can trigger the system to parse and/or analyze the model to identify the features of the part and translate the features to a rendering. In one implementation, the system can: parse the model to extract and/or identify each individual feature of the part (e.g., lines, edges, surfaces, holes, etc.); and map each identified feature to the rendering representing the part, such as a maneuverable, isometric view of the part. The system can then display the rendering to the user (e.g., via the user portal), as shown in FIG. 1.

### 5. User Inputs

Generally, the system can guide the user through the module (e.g., via a sequence of prompts) to collect information associated with the part from the user, as shown in FIGS. 1-4. In particular, the system can prompt the user to: input part specifications and part functionality; and select critical features in the rendering. The system can then compile the user inputs to generate the engineering drawing.

### 5.1 Part Specifications

In one implementation, the system can prompt the user to input a set of part specifications representing metadata associated with the part, as shown in FIG. 1. For example, the system can prompt the user to input a user identifier associated with the user, a set of drawing identifiers unique to the drawing (e.g., a project identifier, a drawing identifier, etc.), a numerical revision identifier, a part material, a part finish, a manufacturing process, a unit, a scale, and/or a timestamp corresponding to a time of the drawing. In particular, in this implementation, the system can generate a title block for the engineering drawing based on the set of part specifications received from the user.

### 5.2 Overall Tolerance Specification

In another implementation, the system can prompt the user to input an overall tolerance tightness for the part, denoting a standard tolerance for the engineering drawing. For example, the system can prompt the user to specify a particular tolerance, such as a high precision tolerance, a standard machining tolerance, or a rough-cut tolerance. In particular, in this implementation, the system can assign the standard tolerance to each non-target feature in the engineering drawing, based on the user-selected target features, as described in more detail below.

In one variation, the system can store a set of preferences defined for a particular user and/or entity. For example, the system can: identify a particular manufacturer indicated by the user in the set of part specifications; access a profile associated with the manufacturer from a library of manufacturer profiles, the profile indicating a high-precision tolerance specified by the manufacturer; and automatically populate a field-corresponding to the overall tolerance tightness-in the module with a value associated with a high-precision tolerance. Therefore, the system can selectively prompt the user based on stored preferences.

### 5.3 Part Function

In another implementation, the system can prompt the user to indicate a function of the part (e.g., via the user portal), the function establishing a design intent for the particular part (i.e., a functionality of the part within an assembly) and corresponding to a degree of freedom of the part, as shown in FIG. 1. In particular, in this implementation, the system can prompt the user to indicate a function of the part by selecting a particular movement of the part, (e.g., a fixed configuration, a rotatable configuration, a translatable configuration, and/or a free-floating configuration). The system can then: define a constrained degree of freedom for the part based on the function indicated by the user; and derive a quantity of datums required to properly constrain the part based on the constrained degree of freedom. For example, in response to receiving indication of a fixed part movement from the user (i.e., the part is fixed within the assembly), the system can define a combination of six constrained degrees of freedom for the part and a quantity of three datums required to constrain the part.

### 5.4 Target Feature Selection

In another implementation, the system can prompt the user to select a set of target features (e.g., via the user portal), the set of target (or interchangeably “critical”) features including features critical to the functionality of the part and/or features requiring precision dimensioning in the engineering drawing, as shown in FIG. 2. In particular, in this implementation, the system can prompt the user to select the set of target features, from the rendering, such as one or more mating features, movement-driving features (e.g., a surface that translates along an axis, two surfaces that rotate around the axis, etc.), movement-restricting features (e.g., a fixed surface, a surface restricted by another surface), aesthetic features (e.g., an edge subject to additional surface finishing), and/or features requiring precise dimensioning. Additionally, the system can prompt the user to input a particular dimension (e.g., length) corresponding to a target feature. The system can then leverage the target features identified by the user to: classify and/or prioritize the essential features of the part requiring precise manufacturing; and define a set of datums for the engineering drawing.

### 6. Datum Selection

Generally, the system can define a set of datums, each datum representing a plane, an axis, a point, or a zone and defining a reference for establishing dimensional measurements and geometric tolerancing for other features in the engineering drawing. In one implementation, in response to receiving selection of the set of target features from the user, the system can: isolate a subset of target features, in the set of target features, that in combination constrain the part according to the constrained degree of freedom; and define a set of datums intersecting the subset of target features. For example, the system can: receive indication of a fixed part from the user; and receive selection of a set of four target features including a first plane, a second plane, parallel to the first plane, a first hole, perpendicular to the first plane, and a second hole, perpendicular to the first plane. The system can then: define a combination of six constrained degrees of freedom for the part; and isolate a subset of target features that, in combination, constrain the part according to the six degrees of freedom. In particular, in this example, the system can isolate: the first plane, restricting three degrees of freedom; an axis at an intersection between a center axis of the first hole, the first plane, and the second plane, restricting two degrees of freedom; and a point at an intersection between a center axis of the second hole and the first plane, restricting one degree of freedom. The system can then define the set of datums intersecting with the user-specified target features, the set of datums including: a primary datum corresponding to the first plane; a secondary datum corresponding to the axis; and a tertiary datum corresponding to the point. Therefore, the system can efficiently select a set of datums intersecting with the set of target features indicated by the user, thereby instantiating a datum reference frame (DRF) from which the part can be localized and measured from according to the parts functional requirements while reducing a quantity of dimensional callouts required in the engineering drawing

### 7. View Types

In one implementation, the system can populate the engineering drawing with a set of projections of the rendering (e.g., a set of two-dimensional and/or three-dimensional views). In particular, the system can populate the engineering drawing with one or more views representing the part (e.g., a front view, orthogonal view, isometric view, auxiliary view, and/or section view). In this implementation, for each feature, in the set of features, the system can: extract a characteristic of the feature from the rendering; and retrieve a view type defined for the feature based on the characteristic. The system can then repeat this process for each feature to compile a set of views for the engineering drawing. Therefore, the system can select and/or consolidate the set of views based on the view type specified for each feature, thereby eliminating the unnecessary or redundant views of the part.

### 8. Translation of User Inputs

Generally, the system can transpose each set of user inputs and the datums into a set of annotations for the engineering drawing. In particular, the system can generate: a set of datum callouts representing each datum; a set of feature control frames representing specified dimensions for the set of target features; a set of basic dimension callouts representing dimensions relative to the set of datums; and a set of reference dimension callouts representing maximal dimensions of the part. The system can then annotate the set of projections to create the engineering drawing.

### 8.1 Datum Callouts

In one implementation, the system can annotate the set of projections with the set of datum callouts representing each datum. In this implementation, for each feature in the subset of target features, the system can: generate a datum callout based on the datum corresponding to the feature; and annotate an edge, depicting the feature in the set of projections, with the datum callout. In one example, the system can define a primary datum corresponding to a plane, a secondary datum corresponding to an axis, and a tertiary datum corresponding to a point. In particular, in this example, the system can generate a primary datum callout (e.g., an “A” enclosed within a box and a leader line extending from the box to a feature), a secondary datum callout (e.g., a “B” enclosed within a box and a leader line extending from the box to a feature), and a tertiary datum callout (e.g., a “C” enclosed within a box and a leader line extending from the box to a feature). The system can then populate the set of projections with the set of datum callouts by: annotating a first edge depicting the plane with the primary datum callout; annotating a second edge depicting the axis with the secondary datum callout; and annotating a third edge depicting the point with the tertiary datum callout.

### 8.2 Feature Control Frames

In another implementation, the system can annotate the set of projections with a set of feature control frames representing the GD&T requirements for each feature, in the set of target features selected by the user. In particular, the system can generate the set of feature control frames including a geometric characteristic symbol (e.g., flatness), a diameter symbol, a tolerance dimension (e.g., ±0.001), a datum reference (e.g., relative to the primary datum), and/or a tolerance modifier (e.g., maximal material condition). In this implementation, for each feature in the subset of target features, the system can: extract a characteristic of the feature from the rendering; retrieve a nominal tolerance for the feature based on the characteristic; generate a feature control frame for the feature based on the characteristic, the nominal tolerance, and a datum; and annotate an edge, depicting the feature in the set of projections, with the feature control frame. In one variation, in response to receiving selection of an overall tolerance tightness from the user (e.g., via the user portal), the system can retrieve a nominal tolerance for the feature based on the characteristic and the overall tolerance tightness specified by the user.

### 8.3 Basic Dimension Callouts

In another implementation, the system can annotate the set of projections with a set of basic dimension callouts representing feature positions relative to one or more datums. In particular, the system can generate the set of basic dimension callouts representing a dimension of each feature, in the set of target features, numerically related to one or more datums (e.g., a numerical distance between a center of a first hole and a center of a second hole, enclosed within a box). In this implementation, the system can: generate a set of basic dimension callouts representing a numerical dimension relative to a datum, in the set of datums; and annotate a set of edges, depicted in the set of projections, with the set of basic dimension callouts.

### 8.4 Reference Dimension Callouts

In another implementation, the system can annotate the set of projections with a set of reference dimension callouts representing maximal dimensions of the part. For example, the system can generate a reference dimension callout representing a maximal length of the part (e.g., a maximal numerical distance between two opposing ends of the part, enclosed within parenthesis). In this implementation, the system can: generate a set of reference dimension callouts representing maximal dimensions of the part; and annotate a set of edges, depicted in the set of projections, with the set of reference dimension callouts. Therefore, the system can leverage the inputs received from the user to select the set of callouts for the engineering drawing to reduce redundant callouts, thereby creating a detailed engineering drawing effectively conveying critical part features and dimensions, ensuring precise manufacture for intended functionality.

### 9. Datum+Critical Feature Review

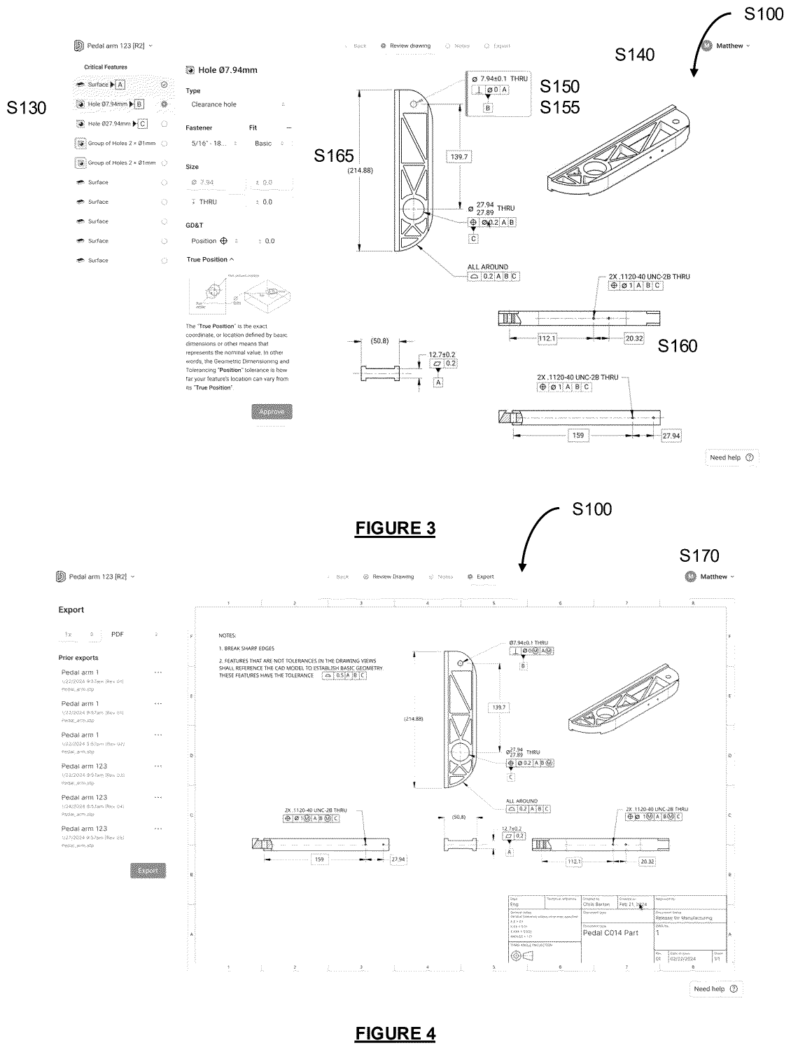

Generally, in response to compiling the user inputs, the system can guide the user through a review and verification process in the module, as shown in FIG. 3. In one implementation, the system can: prompt the user to review the set of datums; and, in response to the user approving the set of datums, populate the set of projections of the rendering with the set of datums, the set of feature control frames, the set of basic dimension callouts, and the set of reference dimension callouts. The system can then: populate each critical feature with a set of characteristics (e.g., feature type, fastener type, size, etc.); prompt the user to review the set of characteristics for each datum and critical feature; and prompt the user to approve the drawing. Therefore, the system can prompt the user to review and confirm each drawing element generated, ensuring user agreement with the selections.

### 9.1 Variation: Discrepancies

In one variation, in response to detecting a discrepancy and/or a deviation from the best practices in the set of callouts, the system can alert the user and prompt the user to review the discrepancy. For example, for each feature corresponding to a feature control frame in the engineering drawing, the system can: extract a feature type corresponding to the feature; access a set of best practices (e.g., nominal tolerance) defined for the feature based on the feature type; and, in response to detecting a difference between the set of best practices and the elements in the feature control frame (e.g., a user-selected tolerance), indicate the discrepancy in the feature control frame (e.g., overlay the feature control frame with a red “X”). Therefore, the system can flag deviations from best practices, thereby ensuring accurate engineering drawings and reducing resources allocated to correcting and revising such engineering drawings.

### 9.2 Variation: Fasteners

In another variation, the system can identify a feature configured to receive a fastener and automatically prompt the user to select a matching fastener. In particular, in this variation, in response to detecting a feature configured to receive a fastener (e.g., a threaded bore configured to receive a threaded fastener, a smooth bore configured to receive a pin, etc.) and/or the user identifying a feature configured to receive a fastener in the set of projections, the system can: extract a set of dimensions corresponding to the feature; isolate a set of fasteners (e.g., a screw, bolt, pin, etc.) configured to mate with the feature based on the set of dimensions; and prompt the user to select a fastener from the set of fasteners. Additionally or alternatively, in this variation, in response to receiving selection of a desired fit from the user, the system can isolate the set of fasteners based on the set of dimensions and the desired fit. Additionally or alternatively, in this variation, in response to identifying a fastener, in the set of fasteners, corresponding to a set of fastener dimensions creating an exact match with the set of dimensions, the system can automatically populate a field (e.g., a “fastener” field) with the fastener. Additionally or alternatively, in this variation, in response to detecting a feature configured to receive a fastener, the system can prompt the user to manually input a corresponding fastener. Therefore, the system can accelerate the review process by identifying fastener-receiving features and/or potential fasteners compatible the fastener-receiving features.

### 10. Drawing Generation

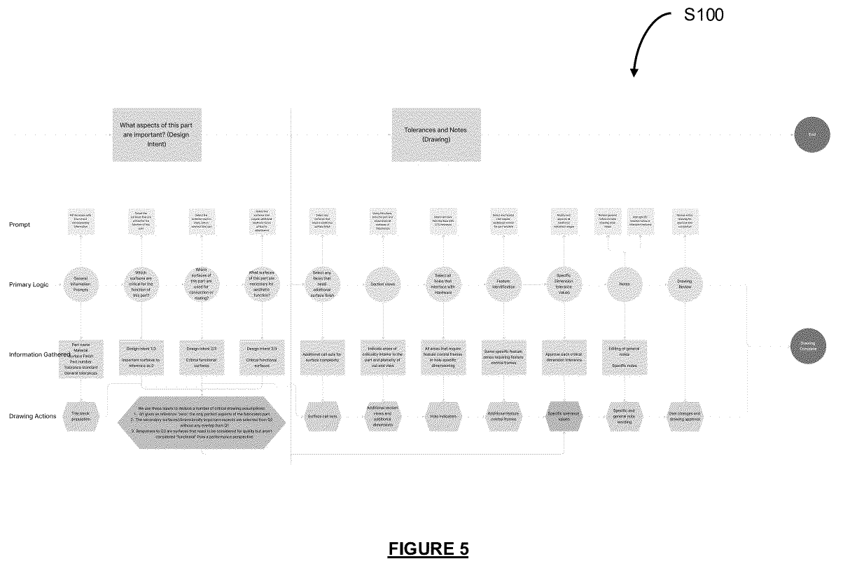

Generally, the system can compile the set of user inputs to render the engineering drawing representing the part, as shown in FIG. 4. In one implementation, in response to the user approving the annotated set of projections, the system can: prompt the user (e.g., via the user portal) to input a set of drawing notes; initialize the engineering drawing; and populate the engineering drawing with the annotated set of projections, a title block, and the set of drawing notes. Therefore, the system can compile the set of user inputs and transpose the model into an engineering drawing effectively conveying critical part features and dimensions, ensuring precise manufacture for intended functionality.

### 11. Revisions: Drawing Feedback

In one implementation, in response to receiving feedback (e.g., manufacturer feedback), the system can facilitate engineering drawing revisions to reflect modifications. In this implementation, the system can: access the set of annotated projections including the set of datums, the set of feature control frames, the set of basic dimension callouts, and the set of reference dimension callouts; populate each critical feature with the set of characteristics (e.g., feature type, fastener type, size, etc.); receive an updated selection from the user (e.g., an increased feature size); and regenerate the engineering drawing representing the updated selection. In particular, in this implementation, the system can regenerate the engineering drawing such that each callout, in the set of callouts, maintains consistent positioning relative to the original engineering drawing. Therefore, the system can: accelerate the revision process by facilitating access to the set of callouts in the original engineering drawing; and generate revised drawings representing conspicuous changes by maintaining consistent positioning of unrevised drawing elements.

### 12. Revisions: Model Revisions

In one implementation, in response to receiving a modified version of the model from the user corresponding to a modified version of the part, the system can associate the modified model with the unmodified model and leverage user-selected parameters from the unmodified model to expedite the drawing generation process for the modified model. In this implementation, at a first time, the system can implement methods and techniques described above to generate an engineering drawing representing an unmodified model of an unmodified part. In particular, in this implementation, the system can assign and/or label each feature of the unmodified part with a feature identifier unique to the feature. In response to receiving a modified model of a modified part (i.e., a modified version of the unmodified part), at a second time succeeding the first time, the system can: identify the modified model as a revision of the unmodified model based on a set of intersecting features in the modified model intersecting with the set of features of the unmodified model; extract a set of intersecting feature identifiers corresponding to the set of intersecting features from the unmodified model; and assign a set of feature identifiers to each feature of the modified model based on the set of intersecting feature identifiers. In response to the set of intersecting features including each critical feature selected for the unmodified model, the system can: define a set of datums for the modified model based on the set of datums of the unmodified model; define a set of callouts for the modified model based on the set of callouts of the unmodified model; populate a set of projections of the modified model with the set of datums and the set of callouts; and populate the sequence of prompts with the set of user inputs selected for the intersecting set of features from the unmodified model. The system can then: define a set of non-intersecting features (i.e., features in the modified model that do not overlap with the features of the unmodified model); and prompt the user to review the set of non-intersecting features (e.g., feature characteristics, tolerances, etc.). The system can then generate a new engineering drawing representing the modified part. Therefore, the system can leverage user-selected parameters (e.g., datums, feature callouts, etc.) from the unmodified model to expedite the drawing generation process for the modified model.

### 13. Asymmetrical Deviation Tolerances

In one implementation, the system can update particular tolerance dimensions based on the recipient specified for the engineering drawing. For example, in response to identifying a manufacturer as the recipient of the engineering drawing, the system can: identify a set of feature control frames, in the engineering drawing, including asymmetric tolerance dimensions (e.g., a hole diameter specifying a tolerance of +0.05, −0); and redefine each asymmetric tolerance dimension as a symmetric tolerance dimension (e.g., the hole diameter specifying a tolerance of ±0.025). Therefore, the system can redefine asymmetric tolerance dimensions to indicate an acceptable symmetrical dimensional variation for a feature.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a model of a part;
generating a rendering of the model, the rendering depicting a set of features of the part, within a user portal;
prompting a user to indicate a function of the part, the function defining a constrained degree of freedom for the part;
prompting the user to select a set of target features on the rendering;
isolating a subset of target features, in the set of target features, that in combination constrain the part according to the constrained degree of freedom;
defining a set of datums intersecting the subset of target features;
populating an engineering drawing with a set of projections of the rendering;
for each feature in the subset of target features:
accessing a feature type corresponding to the feature;
accessing a set of best practices for a set of datum callouts based on the feature type;
generating a datum callout based on a datum, in the set of datums, and the set of best practices corresponding to the feature; and
annotating a set of edges, depicting the feature in the set of projections, with the datum callout;
for each feature in the set of target features:
extracting a characteristic of the feature from the rendering;
retrieving a nominal tolerance for the feature based on the characteristic;
generating a feature control frame, in a set of feature control frames, for the feature based on the characteristic, the nominal tolerance, and a datum; and
annotating an edge, depicting the feature in the set of projections, with the feature control frame;
generating a set of basic dimension callouts representing a numerical dimension relative to a datum, in the set of datums;
annotating a set of edges, depicted in the set of projections, with the set of basic dimension callouts;
generating a set of reference dimension callouts representing maximal dimensions of the part;
annotating a set of edges, depicted in the set of projections, with the set of reference dimension callouts; and
rendering the engineering drawing.
